(19) United States
(12) Patent Application Publication
(10) Pub. No.: US 2026/0327477 A1
(43) Pub. Date: Oct. 22, 2026

(54) METHOD FOR OIL WELL COMPLETION IN PRE-SALT CARBONATE FORMATIONS WITH EARLY INJECTIVITY INDUCTION

(71) Applicant: Petróleo Brasileiro S.A. - PETROBRAS, Rio de Janeiro (BR)

(72) Inventors: Nilson Jose Denadai, Santos (BR); Mauricio Silva, Santos (BR); Kaio Augusto Gonzaga, Vitória (BR); Roger Savoldi Roman, Santos (BR); Eduardo Schnitzier, Santos (BR)

(21) Appl. No.: 19/424,513

(22) Filed: Dec. 18, 2025

(30) Foreign Application Priority Data
Dec. 22, 2024 (BR) 1020240270398

(51) Int. Cl. C09K 8/536; C09K 8/528; E21B 37/06

(52) U.S. Cl. CPC C09K 8/536; C09K 8/528; E21B 37/06

(57) ABSTRACT

The present invention relates to a method of oil well completion with early injectivity induction, promoting the removal of the damage caused by drilling in a stage prior to the installation of the production column and subsea Christmas tree and without the need to use coiled tubing, achieving sufficient initial injectivity, but not excessive, so that the subsequent acid treatment can reach the formation without risk of fracturing, reducing the operation time and the risks associated with the use of this equipment.

### RELATED APPLICATIONS

This application claims the benefit of priority to Brazilian Patent Application No. 1020240270398, filed Dec. 22, 2024, the entire contents of which are incorporated herein by reference.

### FIELD OF THE INVENTION

This invention belongs to the field of drilling and completion of wells, and refers to a method for oil well completion in pre-salt carbonate formations with early injectivity induction. Through the proposed method, it is possible to perform injectivity induction of most wells with an intelligent completion system in pre-salt without the use of coiled tubing, by displacing acid systems from the surface from the early stages of the treatment. This, in turn, allows for the removal of the filter cake from the wellbore walls at an early stage, without the need to install the production column and the subsea Christmas tree.

### BACKGROUND OF THE INVENTION

The carbonate reservoirs of the Santos Basin pre-salt typically have significant extensions, which hinders well-distributed stimulation throughout the range of interest, since the working flow has limitations due to equipment and the access of the fluid to the formation occurs through a single point.

Thus, most of the development wells of the pre-salt pole production are equipped with intelligent completion systems, which usually do not have decoupled lower completion. Thus, the formation, exposed by the perforation of the production casing, is only isolated after the installation of the production column and the setting of the feed-through packers. Due to this characteristic, any massive acid stimulation operation should be performed only after the installation of the production column, in order not to induce a level of (fluid loss that prevents the continuation of the completion installation operations, as a loss above a certain level can cause damage to the mechanical annular barriers and the packer seal bore, preventing its correct settlement. In addition, there is an additional risk if there is a failure in the elements of the production column, as it should be removed with loss of circulation.

Usually, the acidifications carried out prior to the invention, in the Santos Basin pre-salt, required the use of a coiled tubing to assist in diverting the treatment and in displacing the initial acid front to the bottom. This positioning is performed with a return through the annulus between the well and the production column, something that is not possible with the production column and drill pipe riser, since there is no circulation point between the bottom and the surface. In addition, the coiled tubing allows the use of hydro blasting tools, which can contribute to the entry of the acid in the interval where it is desired to increase the initial injectivity.

The frequent use of coiled tubing in the first dozens of wells equipped with intelligent completion significantly impacted the duration and cost of the wells, while there were some doubts about the real need for its use in all cases. From a safety point of view, the use of this equipment requires the mobilization of a dedicated team and a greater number of people on board the completion rig; it adds operational risks, as it involves high pressures, working at height with heavy equipment, transporting loads and assemblies. Some occurrences of incidents were recorded in various stages of the logistics and operation of this equipment. Therefore, an alternative to its use is always desirable and results in greater safety and economy in the construction of the well. In order to optimize the development projects of the pre-salt production, the completion project team sought new alternatives to carry out the acid carbonate treatments without resorting to the use of coiled tubing as a mandatory resource, maintaining the same standards of well safety and quality of the stimulation generated.

Thus, the optimization of the productivity of the wells depends on effective stimulation, that is, the formation of preferential paths (wormholes) along the section to be treated. However, in order for the volume of product to reach the formation and start the treatment itself, it is necessary to remove the damage caused by drilling, so that the inert fluid ahead of the acid is injected into the formation. Hence, before the main stage of acidification, a preliminary operation is usually carried out to remove this damage and obtain an initial injectivity, which allows the acid to reach the formation without risk of fracturing the rock. This damage removal operation was traditionally performed with the aid of coiled tubing, to induce the injectivity necessary for positioning the hydrochloric acid at the base of the lower interval. It is worth noting that this operation with coiled tubing was carried out at a later stage of completion with the production column and the subsea Christmas tree already installed in order to reduce the risks of operational discontinuity in the event of severe loss.

### STATE OF THE ART

Some state of the art documents present solutions for the pretreatment of oil wells, for example:

Document EP0040442 A1 refers to a process that aims to improve the production of oil wells by preventing the formation of scale that can obstruct flow. It uses an aqueous solution that, when injected, initially maintains a high pH to prevent precipitation, but then lowers the pH slowly, causing a scale inhibitor to form exactly where it is needed. This approach is novel as it combines different chemical compounds in a controlled manner, ensuring that the solution acts effectively in the right location, improving the efficiency of oil extraction.

Document U.S. Pat. No. 8,733,443 B2 refers to a method for preparing a horizontal well for injecting water into a carbonate reservoir for acid treatment. First, the pressure of the fluids in the well is kept higher than the natural pressure of the reservoir. Then, a valve is opened to reduce this pressure, allowing fluids from the reservoir to enter the well and push undesirable fluids out. The well is then operated in a controlled manner to remove these undesirable materials. The fluids produced are monitored until the amount of undesirable materials reaches an acceptable level. After that, production is stopped and acid treatment is carried out in the well. This process helps to ensure that acid treatment is most effective.

Document RU2215137 C1 refers to a method for developing an oil well. First, tubes are lowered with a packer, which helps control the pressure. The clay solution in the well is replaced with a lighter liquid, maintaining the pressure in the reservoir. Then, the packer is closed and the device is lowered to the wellbore bottom. The method involves alternating pressures using calcium chloride solutions to clean the well and allow fluids to enter the reservoir. During the process, the clay solution is gradually replaced with lighter solutions. Finally, the well is drilled down to the flame, ensuring that the correct pressure is maintained at all stages.

Document CA1217130 A refers to a method for removing and preventing scale formation in wells that draw fluids from subsurface. The method involves three main steps. First, an aqueous solution of mineral acid is injected into the well to remove existing scale. Then, an EDTA solution is injected, which also helps to eliminate scale. Finally, a scale inhibitor is injected into the well to prevent new scale from forming.

This method is effective in maintaining well efficiency and improving fluid production.

Document U.S. Pat. No. 4,122,896 A refers to a process for slowly acidifying carbonate materials in wells that communicate with underground formations. It involves creating an aqueous solution containing a chlorocarboxylic acid salt and that is almost acid-free. The solution is designed so that, at the temperature of the underground formation, the salt slowly decomposes, releasing an acid that reacts with calcium or magnesium carbonates. This results in the formation of soluble salts that can be removed. The solution is injected into the soil in a controlled manner, ensuring that the carbonate material is treated before there is enough acid to dissolve a large amount of it. Thus, acidification occurs in a controlled and gradual manner. This method can improve the efficiency of underground resource extraction.

However, none of the documents proposes the solution described in this invention, i.e., carrying out a gentle treatment before settling the column hanger, without using the coiled tubing equipment and without a production column and subsea Christmas tree installed, achieving sufficient initial injectivity, but not excessive, so that the subsequent acid treatment can reach the formation without risk of fracturing, reducing the operating time, as well as the risks associated with the use of this equipment. It is verified that, although the solutions proposed in such documents have been developed in order to increase the initial injectivity, remove and prevent the formation of scales, as well as treat the wells before the acid treatment itself, they are generally based on holistic processes, that is, an analysis is made from the origin of the specific problem to the impacts that it can cause and, from there, actions are proposed to overcome these possible problems in an existing process. That is, the solutions achieved are proposed according to the reality, specificity and context of the moment. In the present invention, the solution achieved aims to solve most of the problems that may appear in the carbonate reservoirs of the pre-salt which, due to their significant extensions, hinder the acid stimulation well distributed throughout the range of interest, minimizing its impacts, while in the selected prior art documents, the solutions found are directed to a specific problem faced, yielding a targeted and objective result to that reality/obstacle faced.

### SUMMARY OF THE INVENTION

The present invention aims to propose a method of oil well completion with early injectivity induction, promoting the removal of the damage caused by drilling in a stage prior to the installation of the production column and subsea Christmas tree and without the need to use coiled tubing, achieving sufficient initial injectivity, but not excessive, so that the subsequent acid treatment can reach the formation without risk of fracturing, reducing the operation time and the risks associated with the use of this equipment.

### DETAILED DESCRIPTION OF THE INVENTION

The present invention refers to a method of oil well completion in pre-salt carbonate formations with early injectivity induction, by carrying out a gentle treatment before settlement of the column hanger, without using the coiled tubing equipment and without production column and subsea Christmas tree installed, increasing the initial injectivity. This method comprises the following steps:
(a) Prepare a volume of 100 to 300 bbl of a solution of filter cake breaker fluid in a rig tank, which can be a solution of EDTA or acetic acid, adding at the end a volume of saturated brine until the desired weight for operation is reached.
(b) After preparation, pump the solution into the well, moving it with water-based completion fluid until it is positioned along the entire interval of interest (perforated or open well). This pumping is performed prior to the settlement of the column hanger, circulating through the production column through the intelligent completion valves with annular return between the production column and casing, and between the drill pipe riser and drill riser.

The method uses a pad that works by complexing metal ions, in this case the calcium from the carbonate rock, but with low corrosive potential, an essential condition for this application. This product is positioned by circulation at the wellbore bottom immediately before the settlement of the column hanger, and it is usually observed an increase or beginning of the loss of fluid to the formation from its contact with the perforated interval. It is gradually injected into the formation by the well supply process itself during subsequent operations.

As the treatment can remain in contact with the completion equipment for many hours until it is fully injected, especially if operational difficulties arise, it is essential that it does not generate a corrosive process or damage to the elastomers.

As previously observed, the treatment is positioned before there is confirmation that all the equipment that makes up the production column is operational, that is, this can be a critical issue, as the well will be stimulated but several operations will still be carried out, such as: tests of the equipment that makes up the completion set, and in case of failure, it may be necessary to pull the production column to correct the problem. In this condition, the fact that the treatment reacts in a contained and slow manner is a key characteristic, as it is not desirable to have an uncontrolled loss of fluid to the formation, which can make it difficult, or even prevent the well from being supplied due to the long duration of the subsequent operations. In addition, the induction of severe loss by the overtreatment can cause damage to the mechanical annular barriers and the packer seal bore, preventing the correct settlement of these elements.

Early injectivity induction, distributed throughout the upper and intermediate perforated interval (when applicable), allows not only to move the subsequent main treatments by injection to the bottom, but also helps in the distribution of the treatment in these intervals, as it is able to reduce the initial damage in a more homogeneous way, since less contrast is generated between the areas already treated and those not yet reached by the filter cake breaker fluid, as well as the contact time with the formation before the fluid is all injected is increased.

### EXAMPLE OF THE INVENTION

In pre-salt carbonate wells equipped with intelligent completion, the mechanical stage of hydrochloric acid blasting using coiled tubing for injectivity induction was brought forward and replaced with a mild chemical treatment stage by positioning a filter cake breaker fluid pad. This pumping takes place through the intelligent completion valves with annular return between the production and column and casing and between the drill pipe riser and riser. This displacement is carried out immediately before the column hanger is settled, on the last occasion when fluid can circulate through the column. This solution contributes significantly to the reduction of the overall duration of the completion intervention, either by eliminating coiled tubing operations or by the possibility of performing injectivity induction in advance of the installation of the production column and the subsea Christmas tree.

From an economic point of view, the use of coiled tubing implies higher costs in acid treatment, since the historical average duration of use of this equipment represents about 3 rig days. There is also the possibility of additional time due to its availability, delays in assembly, use and disassembly due to adverse weather conditions, thus adding several days to the scope of the operation with consequent increase in costs.

In addition, with the early injectivity induction operation, a better performance is expected in the distribution of the treatment throughout the entire interval of interest, as the incorporation of weaker products increases the probability of a slower and more evenly distributed treatment, resulting in a potential gain in productivity and recovery of hydrocarbons.

It is estimated a reduction of more than 10 days of rig per well from the aforementioned invention, combined with other actions and techniques, being one of the initiatives with the greatest impact in the campaigns for the construction of pre-salt wells in the Santos Basin.

### APPLICATION OF THE INVENTION

In wells equipped with intelligent completion, the standard stimulation strategy adopted in the vast majority of wells, until mid-2015, included an initial stage of treatment to increase initial injectivity and the creation of a preferential flow zone, usually called a loss zone, at the base of the perforations of the lower interval, using coiled tubing equipment. However, after the first successful applications of the completion methodology with early injectivity induction, without using coiled tubing equipment and without production column and subsea Christmas tree installed, this operation began to incorporate the set of good practices used in the completion of Petrobras wells with a similar configuration.

One of the impacts of the acidification strategy with the use of coiled tubing is the need to carry out this operation after the installation of the production column and the subsea Christmas tree. For this reason, in all cases in which the coiled tubing was used, the installation of the subsea Christmas tree was performed with the probe itself, adding a significant time to the duration of the interventions.

The proposed completion method allowed the breaking of the well filter cake without coiled tubing and, consequently, without the previous installation of the production column and subsea Christmas tree, a solution called “early injectivity induction”. In this case, the operations are carried out with the shear riser joint and tubing hanger running tool connected to the column hanger and the intervention with the rig is completed after the blow-out preventer is removed, without the installation of the subsea Christmas tree. Measures to mitigate risks, increase efficiency and other operational contingencies also contributed to consolidate this new completion sequence. The installation of the subsea Christmas tree became the scope of a specialized vessel, which offers superior performance at a significantly reduced cost when compared to the same operation performed with the rig.

Using this new completion sequence, a reduction in rig duration of more than 10 days per well is estimated. Between 2016 and mid-2019, 50 intelligent completion installation interventions were carried out using the above technique, generating savings in rig demand of approximately 500 days. Individually, the development and application of this methodology is one of the initiatives with the greatest impact on well construction campaigns in these areas.

### ADVANTAGES OF THE INVENTION

Economics/productivity
Possibility of performing early injectivity induction before the installation of the subsea Christmas tree. This important practice represents one of the greatest advances, since it allows the installation of the subsea Christmas tree with specialized vessels instead of using a rig, which represents a saving of about 10 rig days per well and accumulated in the order of 500 days of rig, accounted for between 2016 and 2019;
Reduction of chemical costs by using commodities for the preparation of filter cake breaker fluid instead of Service companies registered systems;
Since it does not require the use of coiled tubing, reductions in time of up to 3 days of operation with the rig and potential gain in treatment distribution were observed, with a positive impact on the oil recovery factor. The non-use of the coiled tubing also eliminates the possibility of additional time due to waiting for the availability of this equipment, delays in its assembly, use and disassembly due to adverse weather conditions, which could thus add several days to the scope of the operation with consequent increase in costs.
In addition to the economic and safety advantages associated with the non-use of coiled tubing, this methodology has the potential to promote an increase in well productivity and an improvement in hydrocarbon recovery, as it increases the homogeneity of the treatment throughout the entire exposed interval.
Reduction in the demand for resources for rig operations by making it possible to transfer subsea Christmas tree installation operations to the specialized vessel.
Reduction of the probability of anomalies during installation of the subsea Christmas tree, in view of the greater expertise of the specialized vessel in the same operation with a rig. In addition, in case of anomalies, the impact with this vessel is much lower due to its greater portfolio flexibility and higher equipment maneuvering speed, as they are lowered by cable and not with column.

### Health/safety

From a safety point of view, the use of coiled tubing equipment requires the mobilization of a dedicated team and a greater number of people on board the completion rig. It adds operational risks, as it involves high pressures, working at height with heavy equipment, transporting loads and assemblies. Incidents have been recorded in various stages of the logistics and operation of this equipment, so an alternative to its use is always desirable and certainly results in greater safety in the well construction.
Absence of corrosiveness of the treatment, allowing it to remain in contact for many hours with the completion equipment until it is fully injected, especially in cases where operational difficulties may arise, in which it is essential that it does not cause a corrosive process or damage to the elastomers;

Thus, in general, the key to the success of said completion method was to find an alternative for inducing well injectivity that would create conditions for displacing the acid treatment to be carried out in a subsequent stage, but at the same time would not be aggressive to the equipment, being able to even remain in the well for long periods, and, most importantly, would not induce severe losses so as not to damage the annular mechanical barriers and the packer seal bore, and would also not pose an additional well safety risk in cases where it is necessary to pull the completion for repair after its placement.

1. A method of oil well Completion in pre-salt carbonate formations with early injectivity induction, comprising carrying out a gentle treatment before settlement of the column hanger, without using the coiled tubing equipment and without production column and subsea Christmas tree, increasing the initial injectivity, wherein said gentle treatment comprises the following:
(a) preparing a volume of 100 to 300 bbl of a solution of filter cake breaker fluid in a rig tank, which can be a solution of EDTA or acetic acid, adding at the end a volume of saturated brine until the desired weight for the treatment is reached;
(b) after the preparation, pumping the solution into the well, moving it with water-based completion fluid until it is positioned along the entire interval of interest, mainly perforated and open well, wherein said pumping is performed prior to the settlement of the column hanger, circulating through the production column through the intelligent completion valves with annular return between the production column and casing, and between the drill pipe riser and drill riser.

2. The method, according to claim 1, wherein the method further comprises a pad that acts by complexing metal ions with low corrosive potential.

3. The method, according to claim 2, wherein the pad is positioned by circulation at the bottom of the well immediately before the settling of the column hanger, in which it is gradually injected into the formation by the well supply process itself during subsequent operations.
